(19) United States
(12) Patent Application Publication
(10) Pub. No.: US 2010/0235906 A1
(43) Pub. Date: Sep. 16, 2010

(54) METHOD AND APPARATUS FOR ACTIVATE AN AUTHENTICATION ON A MOBILE DEVICE

(75) Inventor: Onni Michael Berry, Kangasala (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/403,020

(22) Filed: Mar. 12, 2009

(51) Int. Cl. G06F 12/00

(52) U.S. Cl. 726/20

(57) ABSTRACT

In accordance with an example embodiment of the present invention, a mobile device comprising: a processor configured to receive security data from a dongle and activate, on the mobile device, at least one of the following: a power supply, an application, or a login based at least in part on the received security data.

### TECHNICAL FIELD

The present application relates generally to activate an authentication on a mobile device.

### BACKGROUND

An electronic device has a user interface to use applications. Further, there may be different types of user interfaces. The electronic device facilitates application use using these different types of user interfaces.

### SUMMARY

Various aspects of examples of the invention are set out in the claims.

According to a first aspect of the present invention, a mobile device comprising: a processor configured to receive security data from a dongle and activate, on the mobile device, at least one of the following: a power supply, an application, or a login based at least in part on the received security data.

According to a second aspect of the present invention, a method comprising receiving security data from a dongle and activating, on the mobile device, at least one of the following: a power supply, an application, or a login based at least in part on the received security data.

According to a third aspect of the present invention, a dongle, comprising a processor configured to store security data and transmit the security data based at least in part on the security data to a mobile device.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2 is block diagram depicting an electronic device and a dongle operating in accordance with an example embodiment of the invention;

FIG. 3 is block diagram depicting a dongle operating in accordance with an example embodiment of the invention;

FIG. 4 is a flow diagram illustrating an example method for transmitting security data in accordance with an example embodiment of the invention;

FIG. 5 is a flow diagram illustrating an example method for activating at least one of the following: a power supply, an application, or a login in accordance with an example embodiment of the invention; and

FIG. 6 is a flow diagram illustrating an example use case operating in accordance with an example embodiment of the invention.

### DETAILED DESCRIPTION OF THE DRAWINGS

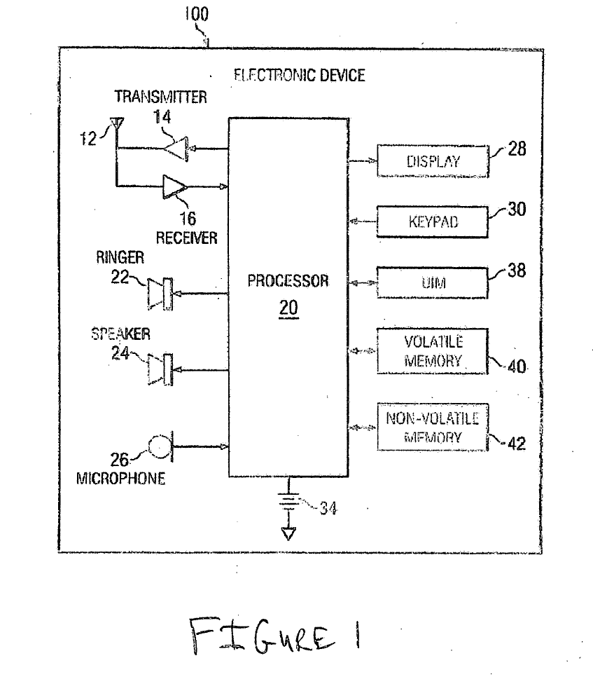

An example embodiment of the present invention and its potential advantages are understood by referring to FIGS. 1 through 6 of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. In an example embodiment, the electronic device 100 may comprises multiple processors, such as processor 20. The processor 20 may provide at least one signal to the transmitter 14 and may receive at least one signal from the receiver 16. In an embodiment, the electronic device 100 may also comprise a user interface comprising one or more input or output devices, such as a conventional earphone or speaker 24, a ringer 22, a microphone 26, a display 28, and/or the like. In an embodiment, the one or more output devices of the user interface may be coupled to the processor 20. In an example embodiment, the display 28 is a touch screen, liquid crystal display, and/or the like.

In an embodiment, the electronic device 100 may also comprise a battery 34, such as a vibrating battery pack, for powering various circuits to operate the electronic device 100. Further, the vibrating battery pack may also provide mechanical vibration as a detectable output. In an embodiment, the electronic device 100 may further comprise a user identity module (UIM) 38. In one embodiment, the UIM 38 may be a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 may comprise memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 may comprise memory. For example, the processor 20 may comprise volatile memory 40, non-volatile memory 42, and/or the like.

In an embodiment, the electronic device 100 may use memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 may comprise circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 may be allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 may be capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 may be capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprises signaling information in accordance with the air interface standard of the applicable cellular system, user speech, received data, user generated data, and/or the like. In an embodiment, the electronic device 100 may be capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

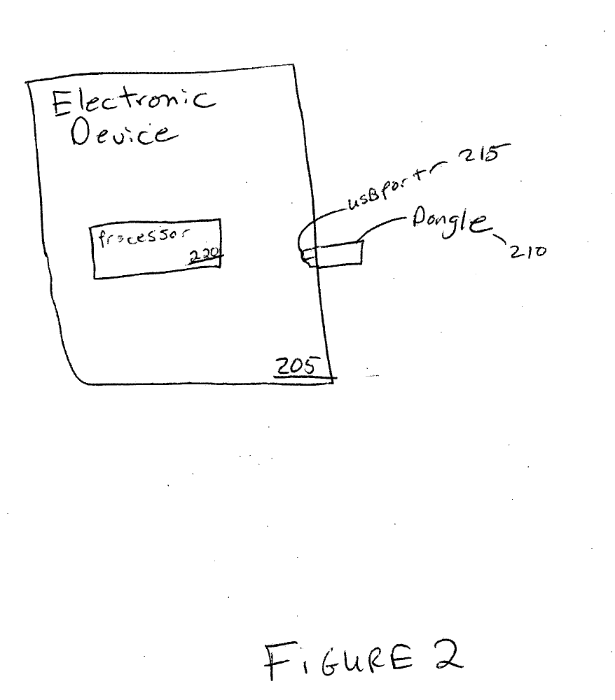

FIG. 2 is block diagram depicting an electronic device 205 and a dongle 210 operating in accordance with an example embodiment of the invention. In an example embodiment, the electronic device 205 comprises a processor 220 and a universal serial bus (USB) port 215. In an alternative embodiment, the electronic device 205 comprises a parallel port, a serial port, and/or the like. In an example embodiment, the electronic device 205 is similar to the electronic device 100 of FIG. 1 and the processor 220 is similar to the processor 20 of FIG. 1. In an alternative embodiment, the electronic device 205 is different than the electronic device 100 of FIG. 1 and the processor 220 is different than the processor 20 of FIG. 1.

In an example embodiment, the processor 220 is configured to receive security data from the dongle 210. For example, the processor receives an encryption key. Further, the processor 220 is configured to activate, on the mobile device, at least one of the following: a power supply, an application, or a login based at least in part on the received security data. For example, the processor uses the encryption key to access an application on the mobile device. In an embodiment, the application will not execute without the encryption key from the dongle 210.

In an example embodiment, the electronic device 205 comprises at least one of the following: a universal serial port, a parallel port, or a serial port. In an embodiment, the electronic device 205 comprises the universal serial port coupled to the dongle 210. In an alternative embodiment, the electronic device 205 comprises the parallel port coupled to the dongle 210. In yet another alternative embodiment, the electronic device 205 comprises the serial port coupled to the dongle 210. In an embodiment, the dongle 210 is a hardware that connects to a mobile device, the electronic device 215, a computer, and/or the like. It should be understood that electronic device 205 may use any of the connections above or other connections as known in the art to communicate, e.g., request and receive, security data.

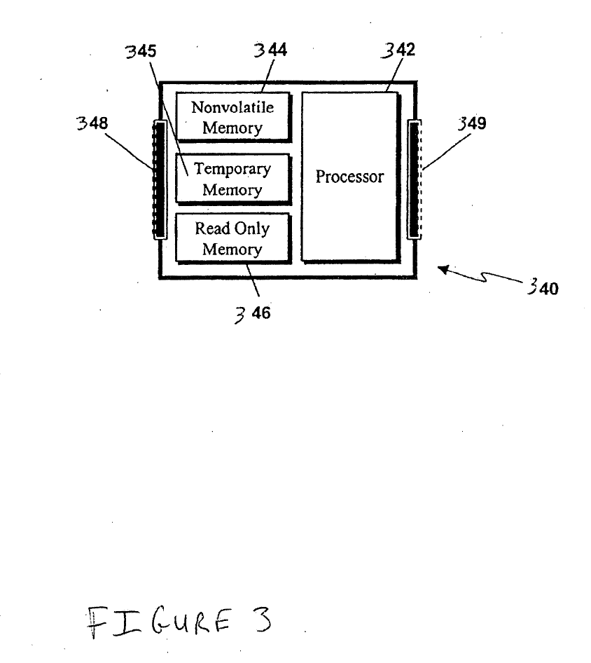

FIG. 3 is block diagram depicting a dongle 340 operating in accordance with an example embodiment of the invention. In an example embodiment, the dongle 340 is a microcontroller comprising a processor 342, a non-volatile memory 344, a temporary random access memory 345, and/or read-only memory 346. In an embodiment, the read-only memory 346 comprises program logic for controlling the processor 342, such as an encryption algorithm for encrypting a seed input to the dongle 340, and an algorithm for decrementing an access counter stored in the non-volatile memory 344 each time the dongle is utilized to access an electronic device, such as electronic device 205 of FIG. 2.

In an embodiment, the dongle also comprises a pair of connectors 348 and 349. In an embodiment, the connector 348 is a male connector adapted to connect to a parallel port of the remote computer 350. In an embodiment, the connector 349 is a female connector adapted to connect to another parallel compatible connector such as a printer cable. In an alternative embodiment, the dongle may comprise a USB connector, radio-frequency identification components, or a Bluetooth wireless interface to enable transfer of a encryption data, such as a generated key number sequence to a client system.

In an example embodiment, the dongle 340 is configured to store security data. In an embodiment, the security data comprise at least an encryption key used for an encryption of communication over a wireless network. In an embodiment, the dongle 340 stores an encryption key in non-volatile memory 344. In such a case, the dongle 340 may transmit the encryption key to a mobile device, a computer, and/or the like. The mobile device of claim 1 wherein the dongle is configured to transmit the security data based at least in part on the security data.

In an alternative embodiment, the dongle 340 may be a security token. In an embodiment, a security token may be a physical device that an authorized user of computer services is given to ease authentication. Security tokens are used to prove one's identity electronically. For example, the token acts like an electronic key to access something.

In yet another alternative embodiment, the dongle 340 may be a hardware token. In an example embodiment, a hardware tokens is hardware configured to store cryptographic keys, such as a digital signature, or biometric data, such as a fingerprint minutiae. Some designs feature tamper resistant packaging, while others may include small keypads to allow entry of a PIN or a simple button to start a generating routine with some display capability to show a generated key number.

In still yet another alternative embodiment, the dongle 340 may be used to decode data. For example, the dongle 340 may decrypt data relating to a service, application, and/or the like. In an embodiment, the absence of the dongle 340 prevents use of a service, application, and/or the like. In an alternative embodiment, data may be presented in an unreadable format without the dongle 340.

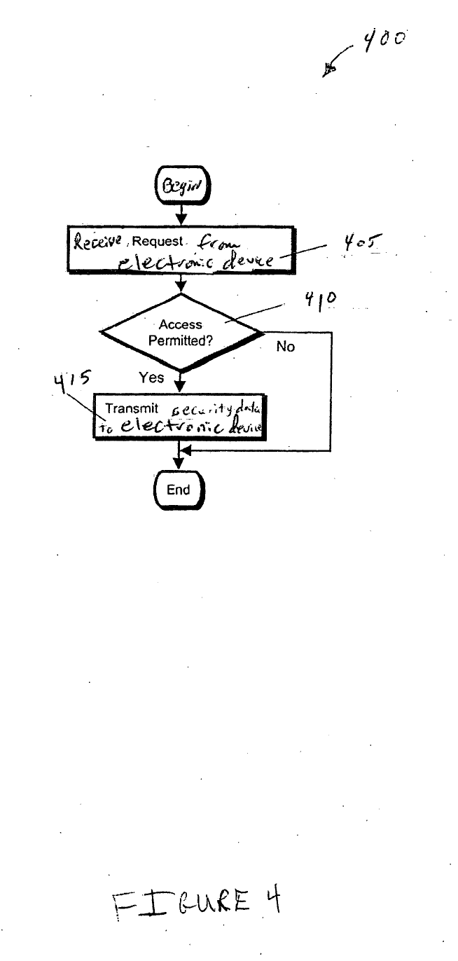

FIG. 4 is a flow diagram illustrating an example method for transmitting security data in accordance with an example embodiment of the invention. Example method 400 may be performed by an electronic device, such as electronic device 205 of FIG. 2.

At 405, a request is received from an electronic device. In an example embodiment, a dongle, such as dongle 210 of FIG. 2, receives a request from the electronic device, such as a mobile device. For example, the mobile device requests security data, such as an encryption key.

At 410, it is determined whether access is permitted. In an example embodiment, the dongle checks stored, for example in non-volatile memory, such as non-volatile memory 344 of FIG. 3. If the flag is set to, for example, 1 then read access is permitted otherwise read access is not permitted. In an alternative embodiment, there is no need to determine whether access is permitted. In yet another alternative embodiment, the dongle provides a security register stored, for example, in memory 344 of FIG. 3. In such a case, the security register may be used for authorizing, e.g., providing access, a mobile device to use an application and/or feature.

If at 410 it is determined that access is permitted, then at 415 security data is transmitted to the electronic device. In an example embodiment, the dongle transmits the security data, such as the encryption key to the mobile device. The example method 400 ends. If at 410 it is determined that no access is permitted, then the example method 400 ends. A technical effect of one or more of the example embodiments disclosed herein is a dongle transmitting an encryption key to a mobile device.

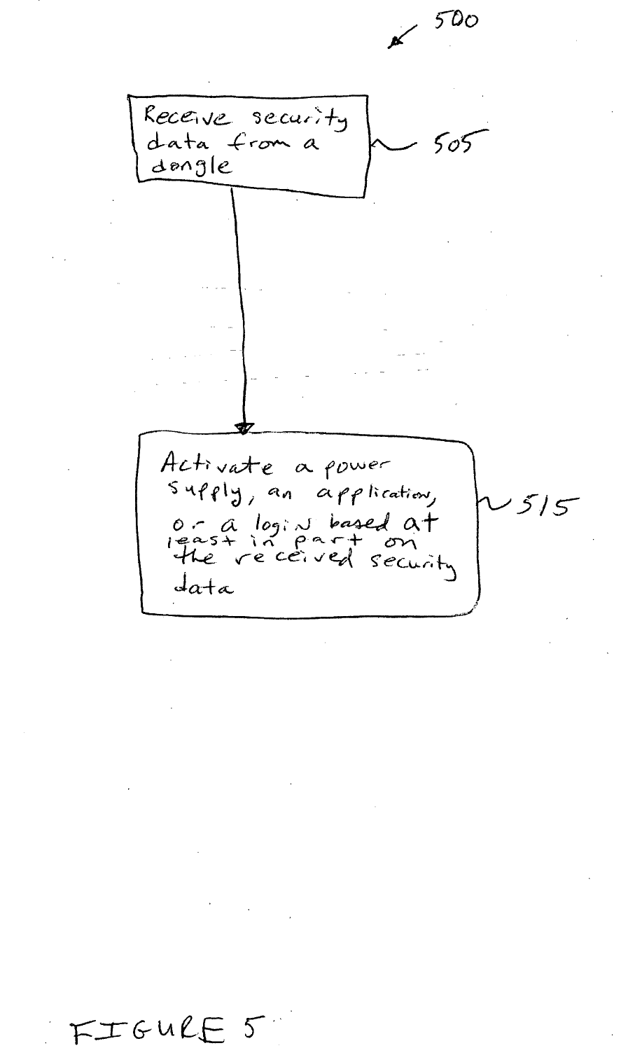

FIG. 5 is a flow diagram illustrating an example method 500 for activating at least one of the following: a power supply, an application, or a login in accordance with an example embodiment of the invention. Example method 500 may be performed by an electronic device, such as electronic device 205 of FIG. 2.

At 505, security data is received from a dongle, such as dongle 210 of FIG. 2. In an example embodiment, a processor, such as processor 220 of FIG. 2, of the electronic device is configured to receive security data from the dongle 210. For example, the processor receives an encryption key.

At 515, a power supply, an application, or a login is activated based at least in part on the received security data. In an example embodiment, the processor is configured to activate, on the mobile device, at least one of the following: a power supply, an application, or a login based at least in part on the received security data. For example, the processor uses the encryption key to login to the mobile device. A technical effect of one or more of the example embodiments disclosed herein is activating a power supply, an application, or a login using a dongle.

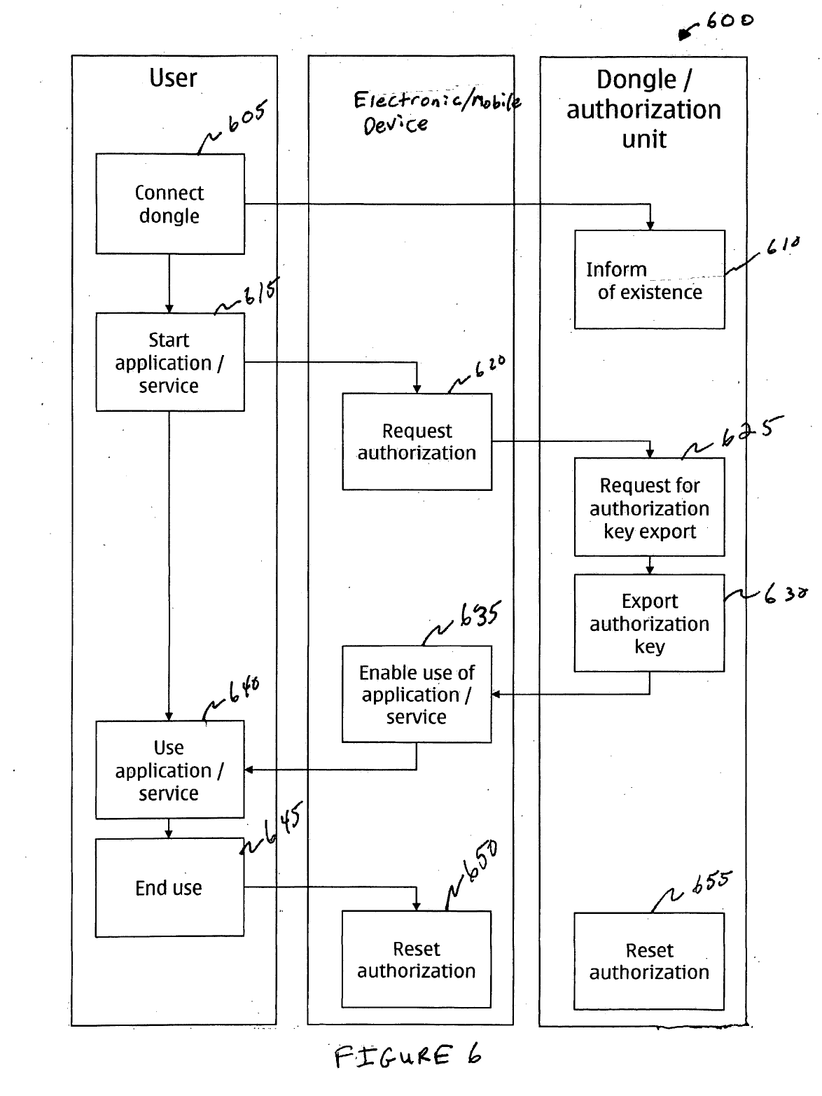

FIG. 6 is a flow diagram illustrating an example use case operating in accordance with an example embodiment of the invention. Example method 600 may be performed by an electronic device, such as electronic device 205 of FIG. 2, and a dongle, such as dongle 340 of FIG. 3.

At 605, a user connects to a dongle, via the electronic device. For example, a user connects a dongle to a mobile device. At 610, the dongle informs of existence. For example, the dongle sends the electronic device notification of presence. At 615, an application and/or service is started. For example, a user starts an application on the mobile device.

At 620, a request for authorization is sent. For example, the mobile device sends an authorization request to the dongle. At 625, the dongle requests an authorization key export based at least in part on the authorization request. At 630, the authorization key is exported. For example, the dongle sends the authorization key to the mobile device.

At 635, the application and/or service use is enabled. For example, the mobile device enables use of the application and/or service using the authorization key received exported at 630.

At 640, the application and/or service is used. For example, the user uses the application and/or service on the mobile device. At 645, the use of the application and/or service is ended. For example, the user closes the application. At 650, the authorization is reset. For example, the mobile device resets the authorization. At 655, the authorization is reset. For example, the dongle resets the authorization. The example method 600 ends.

Without in any way limiting the scope, interpretation, or application of the claims appearing below, a technical effect of one or more of the example embodiments disclosed herein may be activating a power supply, an application, or a login using a dongle. Another technical effect of one or more of the example embodiments disclosed herein may be a dongle transmitting an encryption key to a mobile device.

Embodiments of the present invention may be implemented in software, hardware, application logic or a combination of software, hardware and application logic. The software, application logic and/or hardware may reside on an electronic device or a dongle. If desired, part of the software, application logic and/or hardware may reside on an electronic device and part of the software, application logic and/or hardware may reside on a dongle. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A mobile device, comprising:
a processor configured to:
receive security data from a dongle; and
activate, on the mobile device, at least one of the following: a power supply, an application, or a login based at least in part on the received security data.

2. The mobile device of claim 1 wherein the security data comprise at least an encryption key used for an encryption of communication over a wireless network.

3. The mobile device of claim 1 further comprising at least one of the following: a universal serial port, a parallel port, or a serial port.

4. The mobile device of claim 3 wherein the universal serial port is coupled to the dongle.

5. The mobile device of claim 3 wherein the parallel port is coupled to the dongle.

6. The mobile device of claim 3 wherein the serial port is coupled to the dongle.

7. The mobile device of claim 1 further configured to request security data from the dongle.

8. The mobile device of claim 1, wherein the processor comprises at least one memory that contains executable instructions that if executed by the processor cause the apparatus to receive security data from a dongle; and activate, on the mobile device, at least one of the following: a power supply, an application, or a login based at least in part on the received security data.

9. A method comprising:
receiving security data from a dongle; and
activating, on the mobile device, at least one of the following: a power supply, an application, or a login based at least in part on the received security data.

10. The method of claim 9 wherein the security data comprise at least an encryption key used for an encryption of communication over a wireless network.

11. The method of claim 9 further comprising at least one of the following: a universal serial port, a parallel port, or a serial port.

12. The method of claim 11 wherein the universal serial port is coupled to the dongle.

13. The method of claim 11 wherein the parallel port is coupled to the dongle.

14. The method of claim 11 wherein the serial port is coupled to the dongle.

15. The method of claim 9 further comprising requesting security data from the dongle.

16. A dongle, comprising:
a processor configured to:
store security data; and
transmit the security data based at least in part on the security data to a mobile device.

17. The dongle of claim 16 wherein the security data comprise at least an encryption key used for an encryption of communication over a wireless network.

18. The dongle of claim 16 further comprising at least one of the following: a universal serial port, a parallel port, or a serial port.

19. The dongle of claim 16 wherein the universal serial port is coupled to the dongle.

20. The dongle of claim 16 wherein the parallel port is coupled to the dongle.

21-35. (canceled)
